(19) United States
(12) Patent Application Publication
(10) Pub. No.: US 2024/0014941 A1
(43) Pub. Date: Jan. 11, 2024

(54) Methods And Apparatus For Disabling And Enabling HARQ Feedback For Multi-TB In IoT NTN

(71) Applicant: MediaTek Singapore Pte. Ltd., Singapore (SG)

(72) Inventors: Wen Tang, Beijing (CN); Gilles Charbit, Cambridge (GB); Yao-Hua Cai, Shanghai (CN)

(21) Appl. No.: 18/219,177

(22) Filed: Jul. 7, 2023

(30) Foreign Application Priority Data
Jul. 7, 2022 (WO) PCT/CN2022/104345
Jun. 30, 2023 (CN) 202310777756.6

(51) Int. Cl. H04L 1/1812; H04W 72/232; H04L 1/1867

(52) U.S. Cl. CPC H04L 1/1812; H04W 72/232; H04L 1/1887

(57) ABSTRACT

Various examples and schemes pertaining to enabling or disabling hybrid automatic repeat request (HARQ) feedback for multi-transport block (multi-TB) in an Internet-of-Things (IoT) non-terrestrial network (NTN) are described. A user equipment (UE) receives a configuration (e.g., from a network). Then, the UE applies the configuration to disable or enable a HARQ feedback regarding multiple TBs.

### CROSS REFERENCE TO RELATED PATENT APPLICATION(S)

The present disclosure claims the priority benefit of China Patent Application No. 202310777756.6, filed 28 Jun. 2023, which is part of a China national stage application of PCT Application No. PCT/CN2022/104345, filed 7 Jul. 2022. Contents of aforementioned applications are herein incorporated by reference in their entirety.

### TECHNICAL FIELD

The present disclosure is generally related to wireless communications and, more particularly, to disabling and enabling hybrid automatic repeat request (HARQ) feedback for multi-transport block (multi-TB) in an Internet-of-Things (IoT) non-terrestrial network (NTN).

### BACKGROUND

Unless otherwise indicated herein, approaches described in this section are not prior art to the claims listed below and are not admitted as prior art by inclusion in this section.

HARQ is mainly used for scheduling management, such as the initial transmission and retransmission of information. In scenarios with relatively small transmission delay, such as a terrestrial network (TN) system, there are advantages associated with using HARQ feedback, such as increased transmission reliability. On the other hand, in NTN scenarios with large transmission delay, disabling HARQ feedback can reduce user equipment (UE) power consumption and transmission delay. In addition, disabling HARQ feedback for a downlink (DL) transmission can improve uplink throughput in large round-trip time (RTT) scenarios as more resource would be available in uplink. Considering that there could be multiple transport blocks (TBs)s for a HARQ process identification (ID) in an IoT NTN, it would be beneficial to be able to disable and enable HARQ feedback between different TBs. However, at present time, how to configure a UE to disable and enable HARQ feedback for multi-TB scenarios remains to be defined. Therefore, there is a need for a solution of disabling and enabling HARQ feedback for multi-TB in an IoT NTN.

### SUMMARY

The following summary is illustrative only and is not intended to be limiting in any way. That is, the following summary is provided to introduce concepts, highlights, benefits and advantages of the novel and non-obvious techniques described herein. Selected implementations are further described below in the detailed description. Thus, the following summary is not intended to identify essential features of the claimed subject matter, nor is it intended for use in determining the scope of the claimed subject matter.

The present disclosure proposes various schemes with respect to disabling and enabling HARQ feedback for multi-TB in an IoT NTN. It is believed that implementation of one or more of the various schemes proposed herein may address or otherwise alleviate aforementioned issue(s) and/or provide benefits/advantages described above.

In one aspect, a method may involve a UE receiving, from a network, a configuration. The method may also involve the UE applying the configuration to disable or enable a HARQ feedback regarding multiple TBs.

In another aspect, an apparatus implementable in a UE may include a transceiver configured to communicate wirelessly and a processor coupled to the transceiver. The processor may receive, from a network, a configuration. The processor may also apply the configuration to disable or enable a HARQ feedback regarding multiple TBs.

It is noteworthy that, although description provided herein may be in the context of certain radio access technologies, networks and network topologies such as NTN, the proposed concepts, schemes and any variation(s)/derivative(s) thereof may be implemented in, for and by other types of radio access technologies, networks and network topologies such as, for example and without limitation, 5th Generation (5G), New Radio (NR), Long-Term Evolution (LTE), LTE-Advanced, LTE-Advanced Pro, Wireless Fidelity (Wi-Fi) and any future-developed networking and communication technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example communication environment in which various proposed schemes in accordance with the present disclosure may be implemented.

FIG. 2 is a diagram of an example scenario in which various proposed schemes in accordance with the present disclosure may be implemented.

FIG. 3 is a block diagram of an example communication system in which various proposed schemes in accordance with an implementation of the present disclosure.

FIG. 4 is a flowchart of an example process under a proposed scheme in accordance with an implementation of the present disclosure.

FIG. 5 is a flowchart of an example process under a proposed scheme in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to disabling and enabling HARQ feedback for multi-TB in an IoT NTN. According to the present disclosure, a number of possible solutions or schemes may be implemented separately or jointly. That is, although these possible solutions/schemes may be described below separately, two or more of these possible solutions/schemes may be implemented in one combination or another.

In the present disclosure, NTN refers to a network that uses radio frequency (RF) and information processing resources carried on high, medium and low orbit satellites or other high-altitude communication platforms to provide communication services for UEs. According to the load capacity on the satellite, there are two typical scenarios, namely: transparent payload and regenerative payload. In the transparent payload mode, the satellite does not process the signal and waveform in the communication service but, rather, only forwards data as an RF amplifier. In the regenerative payload mode, the satellite, other than RF amplification, also has the processing capabilities of modulation/demodulation, coding/decoding, switching, routing and so on.

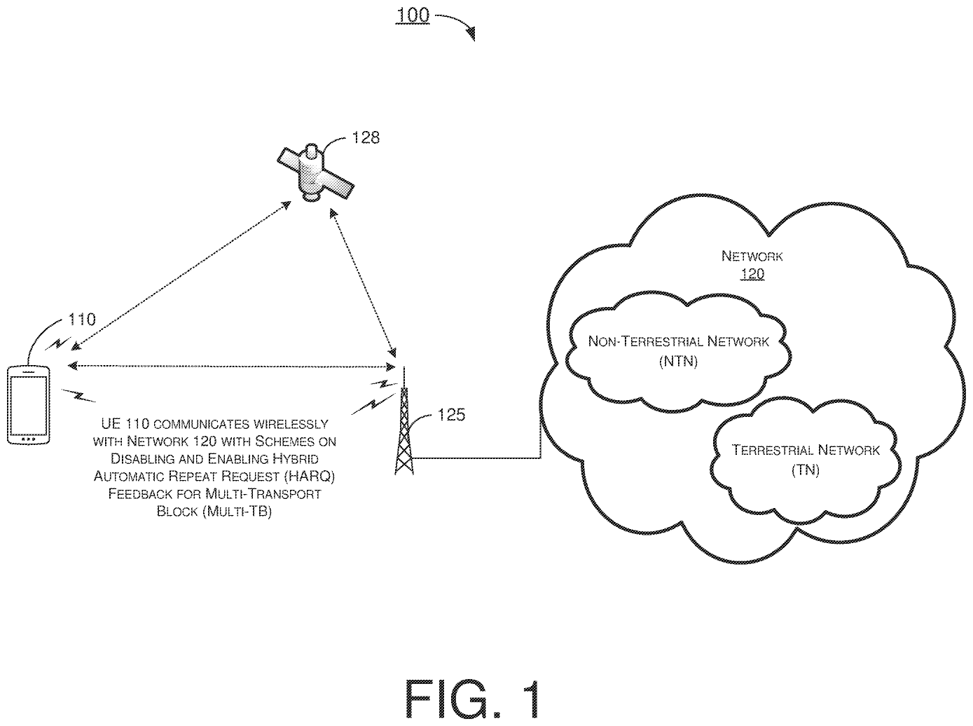

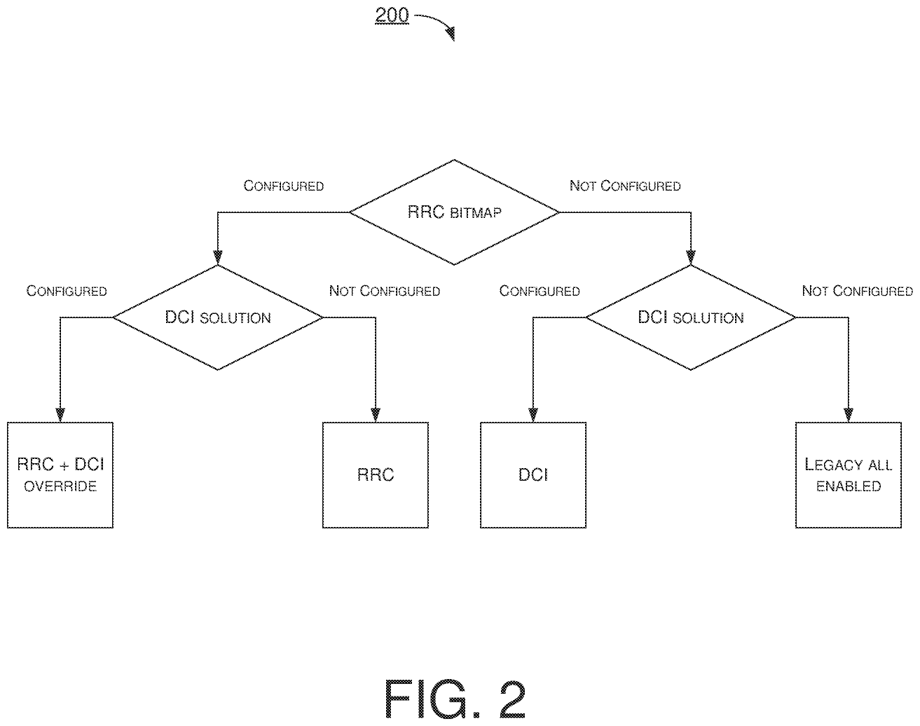

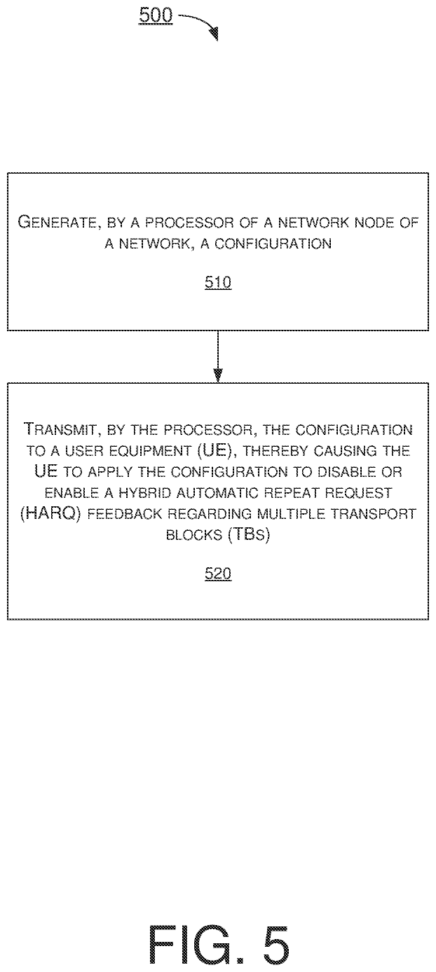

FIG. 1 illustrates an example communication environment 100 in which various solutions and schemes in accordance with the present disclosure may be implemented. FIG. 2˜FIG. 5 illustrate examples of implementation of various proposed schemes in communication environment 100 in accordance with the present disclosure. The following description of various proposed schemes is provided with reference to FIG. 1˜FIG. 5.

FIG. 1 illustrates an example communication environment 100 in which various solutions and schemes in accordance with the present disclosure may be implemented. Referring to FIG. 1, communication environment 100 may involve a UE 110 in wireless communication with a network 120 (e.g., a mobile network including an NTN and a TN) via a terrestrial network node 125 (e.g., gNB, eNB, transmit-and-receive point (TRP)) and/or a non-terrestrial network node 128 (e.g., satellite). In some implementations, UE 110 may be an IoT device such as a narrowband IoT (NB-IoT) UE or an enhanced machine-type communication (eMTC) UE. In communication environment 100, UE 110, network 120, terrestrial network node 125 and non-terrestrial network node 128 may implement various schemes pertaining to disabling and enabling HARQ feedback for multi-TB in an IoT NTN in accordance with the present disclosure, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

In general, an IoT system is mainly divided into NB-IoT and eMTC based on differences in system bandwidth and coverage. Typically, the bandwidth used by an NB-IoT is about 200 kHz and supports the transmission of low traffic data at a rate below 100 kbps. Conversely, eMTC technology typically utilizes 1.4 MHz bandwidth and the maximum data transmission rate is 1 Mbps. Based on the Release 16 specification of the 3 rd Generation Partnership Project (3GPP) standards, there can be multi-TB cases. There is no multi-TB HARQ feedback in a single-cell multicast transport channel (SC-MTCH). There is multi-TB HARQ feedback in unicast, with consideration of HARQ ACK bundling. Besides, for NB-IoT, if a number of scheduled TBs for unicast is present and multiple TBs are configured, the multi-TB (e.g., two TBs) are scheduled together without a corresponding HARQ process number in downlink control information (DCI). For eMTC, different TBs may correspond to different HARQ process numbers. When an IoT device (e.g., UE 110) needs to be used in scenarios with a large delay, disabling HARQ feedback may be required to reduce the transmission delay and increase the transmission information throughput. Accordingly, various proposed schemes in accordance with the present disclosure aim to provide techniques on enabling/disabling HARQ feedback for a multi-TB scenario for IoT devices with a large delay.

Considering the problem of large transmission delay in an NTN system, disabling HARQ feedback for New Radio (NR) NTN may improve the system throughput. For an NR NTN, the disabling of HARQ feedback may utilize the radio resource control (RRC) parameter “HARQ feedback enabling disablingperharqprocess-r17” to pre-configure a HARQ ID corresponding to an enabled feedback and a HARQ ID corresponding to a disabled feedback. When a network (e.g., network 120) performs HARQ scheduling, the network may schedule specific HARQ process(es) with enabling and/or disabling of HARQ feedback through the “HARQ process number” field in DCI. That is, a UE (e.g., UE 110) may be aware of the “HARQ process number” by receiving the DCI from the network. The UE may also know whether to disable HARQ feedback based on the RRC parameter “HARQ feedback enabling disablingperharqprocess-r17.”

Under various proposed schemes in accordance with the present disclosure, with respect to configuration and/or indication of disabling and/or enabling of HARQ feedback, one or more options may exist for DCI-based overriding or indication mechanism in multiple TBs scheduled by a single DCI. Under one proposed scheme, a DCI-based overriding or indication mechanism may be applied to all scheduled TBs. For instance, a single indication may be applied to all scheduled TBs. Alternatively, separate indications may be used such that each indication may be applied to a respective one of the scheduled TBs. Under another proposed scheme, a DCI-based overriding or indication mechanism may be applied to a subset of scheduled TBs. For instance, DCI-based overriding or indication mechanism may be applied to a first TB scheduled by DCI. Alternatively, DCI-based overriding or indication mechanism may be applied to HARQ feedback enabled or HARQ feedback disabled TBs scheduled by DCI. Alternatively, DCI-based overriding or indication mechanism may be applied to TB(s) scheduled by DCI and also configured by a higher layer (e.g., via RRC signaling). Under yet another proposed scheme, whether a DCI-based overriding or indication mechanism for TB(s) may be applied may be determined by a per-HARQ RRC configuration (e.g., all HARQ enabled, all HARQ disabled or mixed HARQ enabled and disabled configuration). Under still another proposed scheme, a DCI-based overriding or indication mechanism may not be applied to multiple TBs scheduled by a single DCI.

Under a first proposed scheme in accordance with the present disclosure, the enabling/disabling of multi-TB acknowledgement (ACK) and negative acknowledgement (NACK) feedback in a NTN may be configured based on one of a plurality of options. In a first option under the first proposed scheme, the enabling/disabling of multi-TB HARQ ACK/NACK feedback may be based on the enabling-disabling configuration of one HARQ process. For instance, the HARQ enabling/disabling configuration of both multi-TB ACK feedback and multi-TB NACK feedback may be based on configuration of the HARQ feedback enabling or disabling for HARQ process ID of 0 for all TBs. In case that the configuration of the HARQ process for the multi-TB corresponds to HARQ feedback enabling, the multi-TB ACK/NACK response (feedback) may be enabled. In case that the configuration of the HARQ process for the multi-TB corresponds to HARQ feedback disabling, the multi-TB ACK/NACK response (feedback) may be disabled.

In a second option under the first proposed scheme, the enabling/disabling of multi-TB HARQ ACK/NACK feedback may be based on a dedicated RRC parameter that indicates enabling or disabling. For instance, with one dedicated RRC parameter configured to indicate enabling, the multi-TB HARQ ACK/NACK response (feedback) may be enabled. Otherwise, in case that the RRC parameter indicates disabling, the multi-TB HARQ ACK/NACK response (feedback) may be disabled. When the dedicated RRC parameter is default, a UE (e.g., UE 110) may determine enabling of the multi-TB ACK/NACK response (feedback) or determine disabling of the multi-TB ACK/NACK response (feedback) or determine enabling/disabling based on the enabling-disabling of the HARQ process for the multi-TB or based on configuration of the HARQ feedback enabling or disabling for HARQ process ID of 0 for all TBs. The dedicated RRC parameter may be updated by a medium access control (MAC) control element (CE) from the network (e.g., network 120).

In a third option under the first proposed scheme, the enabling/disabling of multi-TB HARQ ACK/NACK feedback may be based on a new DCI field (added to existing DCI format) that indicates enabling or disabling. For instance, a one-bit DCI field of “multi-TB HARQ-feedback enabling-disabling” may be added to indicate enabling or disabling of HARQ feedback (e.g., a value of “0” indicates enabling and a value of “1” indicates disabling). In some implementations, this field may only be present in case the UE configured with the higher-layer parameter npdsch-MultiTB-Config is enabled in NB-IoT or with another higher-layer parameter ce-PDSCH-MultiTB-Config is enabled in eMTC.

In a fourth option under the first proposed scheme, the enabling/disabling of multi-TB HARQ ACK/NACK feedback may be based on re-interpretation of an existing DCI field to indicate enabling or disabling. The existing DCI field re-interpreted comprises a HARQ-ACK related field. For NB-IoT, the HARQ-ACK related field is “HARQ-ACK resource” field, and for eMTC, the HARQ-ACK related field is “HARQ-ACK resource offset” field. For instance, for NB-IoT, in case the UE is configured with the higher-layer parameter npdsch-MultiTB-Config enabled, the disabling of HARQ feedback is indicated when “Scheduling delay” field in the DCI=‘000’ and “HARQ-ACK resource” field in the DCI=‘0000’. Otherwise, HARQ feedback may be enabled. Alternatively, when “HARQ-ACK resource” field=‘0000,’ disabling of HARQ feedback may be indicated; otherwise, HARQ feedback may be enabled.

Under a second proposed scheme in accordance with the present disclosure, the enabling/disabling of multi-TB HARQ ACK/NACK response respectively in NTN may be configured based on one of a plurality of options. In case the configuration of one TB in the multi-TBs have HARQ feedback enabled, the HARQ feedback of multi-TBs may be enabled. Alternatively, in case the configuration of one TB in the multi-TBs have HARQ feedback disabled, the HARQ feedback of multi-TBs may be disabled. In a first option under the second proposed scheme, the enabling/disabling of multi-TB HARQ ACK/NACK feedback may be based on a dedicated RRC parameter to indicate enabling or disabling for the multi-TBs. For instance, the dedicated RRC parameter may be configured with two bits of ‘00’ to indicate enabling for a first TB and enabling for a second TB. Additionally, the dedicated RRC parameter may be configured with two bits of ‘01’ to indicate enabling of the first TB and disabling of the second TB. Moreover, the dedicated RRC parameter may be configured with two bits of ‘10’ to indicate disabling for the first TB and enabling for the second TB. Furthermore, the dedicated RRC parameter may be configured with two bits of ‘11’ to indicate disabling for the first TB and disabling for the second TB. The dedicated RRC parameter may be updated by MAC CE.

In a second option under the second proposed scheme, the enabling/disabling of multi-TB HARQ ACK/NACK feedback may be based on a new DCI field to indicate enabling or disabling. For instance, a two-bit DCI field of “multi-TB HARQ-feedback enabling-disabling” may be added to indicate enabling or disabling of HARQ feedback. The two bits of the DCI field may be ‘00’ to indicate enabling for the first TB and enabling for the second TB. Additionally, the two bits of the DCI field may be ‘01’ to indicate enabling for the first TB and disabling for the second TB. Moreover, the two bits of the DCI field may be ‘10’ to indicate disabling for the first TB and enabling for the second TB. Furthermore, the two bits of the DCI field may be ‘11’ to indicate disabling for the first TB and disabling for the second TB. This new field may be present in case the higher-layer parameter of npdsch-MultiTB-Config is enabled and the corresponding DCI is mapped onto the UE-specific search space given by the cell radio network temporary identifier (C-RNTI).

In a third option under the second proposed scheme, the enabling/disabling of multi-TB HARQ ACK/NACK feedback may be based on re-interpretation of an existing DCI field to indicate enabling or disabling. The existing DCI field re-interpreted comprises a HARQ-ACK related field. For NB-IoT, the HARQ-ACK related field is “HARQ-ACK resource” field, and for eMTC, the HARQ-ACK related field is “HARQ-ACK resource offset” field. For instance, for NB-IoT, in case the UE configured with the higher-layer parameter npdsch-MultiTB-Con fig is enabled, the enabling or disabling of the first TB may be determined based on the enabling-disabling configuration of the HARQ process or based on configuration of the HARQ feedback enabling or disabling for HARQ process ID of 0 for the multi-TBs. The disabling for the second TB may be indicated when “Scheduling delay” field in the DCI=‘000’ and “HARQ-ACK resource” field in the DCI=‘0000.’ Otherwise, the second TB may be enabled. Alternatively, when “HARQ-ACK resource” field=‘0000,’ disabling for the second TB may be indicated. Otherwise, the second TB may be enabled.

FIG. 2 illustrates an example scenario 200 in which various proposed schemes in accordance with the present disclosure may be implemented. In scenario 200, for eMTC NTN for coverage enhancement (CE) mode A, an option of per-HARQ process configuration via UE-specific RRC signaling may be utilized to configure or otherwise indicate enabling or disabling of HARQ feedback for DL transmissions. Alternatively, or additionally, an explicit indication by DCI (e.g., by adding a new field or reusing an existing field) may be utilized. Moreover, in scenario 200, for NB-IoT NTN and eMTC NTN for CE mode B, configuration or indication of enabling or disabling of HARQ feedback for DL transmissions may be implemented as that shown in FIG. 2. For instance, an RRC bitmap may be utilized such that each bit of the RRC bitmap may indicate enabling or disabling of the HARQ feedback regarding a respective TB of multiple TBs. In case that RRC signaling is configured, an explicit DCI signaling solution may be either configured or not configured. In case that the DCI signaling is also configured, the indication of enabling or disabling of HARQ feedback may be based on the DCI signaling to override the RRC bitmap. In case that the DCI signaling is not configured, the indication of enabling or disabling of HARQ feedback may be based on the RRC bitmap alone. On the other hand, in case that RRC signaling is not configured, an explicit DCI signaling solution may or may not be utilized. For instance, in case that the DCI signaling is utilized, the indication of enabling or disabling of HARQ feedback may be based on the DCI signaling. In case that the DCI signaling is not utilized, then HARQ feedback may be enabled for all TBs (e.g., in the case of legacy communication).

### Illustrative Implementations

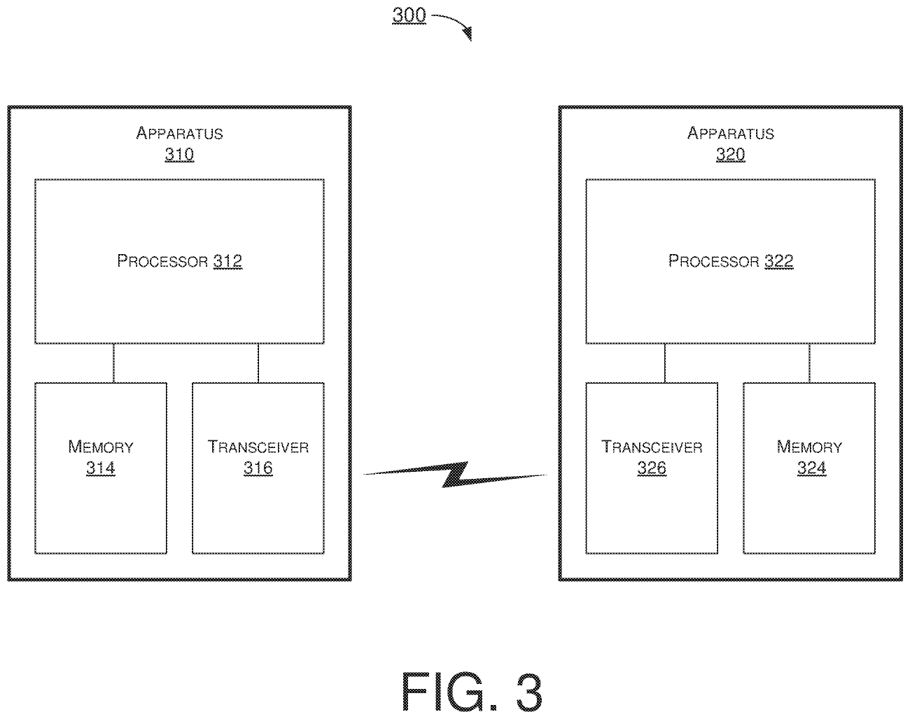

FIG. 3 illustrates an example communication system 300 having an example apparatus 310 and an example apparatus 320 in accordance with an implementation of the present disclosure. Each of apparatus 310 and apparatus 320 may perform various functions to implement schemes, techniques, processes and methods described herein pertaining to disabling and enabling HARQ feedback for multi-TB in an IoT NTN, including various schemes described herein.

Each of apparatus 310 and apparatus 320 may be a part of an electronic apparatus, which may be a UE such as a vehicle, a portable or mobile apparatus, a wearable apparatus, a wireless communication apparatus or a computing apparatus. For instance, each of apparatus 310 and apparatus 320 may be implemented in an electronic control unit (ECU) of a vehicle, a smartphone, a smartwatch, a personal digital assistant, a digital camera, or a computing equipment such as a tablet computer, a laptop computer or a notebook computer. Each of apparatus 310 and apparatus 320 may also be a part of a machine type apparatus, which may be an eMTC or NB-IoT apparatus such as an immobile or a stationary apparatus, a home apparatus, a wire communication apparatus or a computing apparatus. For instance, each of apparatus 310 and apparatus 320 may be implemented in a smart thermostat, a smart fridge, a smart door lock, a wireless speaker or a home control center. Alternatively, each of apparatus 310 and apparatus 320 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Each of apparatus 310 and apparatus 320 may include at least some of those components shown in FIG. 3 such as a processor 312 and a processor 322, respectively. Each of apparatus 310 and apparatus 320 may further include one or more other components not pertinent to the proposed scheme of the present disclosure (e.g., internal power supply, display device and/or user interface device), and, thus, such component(s) of each of apparatus 310 and apparatus 320 are neither shown in FIG. 3 nor described below in the interest of simplicity and brevity.

In some implementations, at least one of apparatus 310 and apparatus 320 may be a part of an electronic apparatus, which may be a vehicle network node or base station (e.g., eNB, gNB, TRP or satellite), a small cell, a router or a gateway. For instance, at least one of apparatus 310 and apparatus 320 may be implemented in an IoT device in an NTN, an IoT NTN, an eNodeB in an LTE, LTE-Advanced or LTE-Advanced Pro network or in a gNB in a 5G, NR, IoT network. Alternatively, at least one of apparatus 310 and apparatus 320 may be implemented in the form of one or more IC chips such as, for example and without limitation, one or more single-core processors, one or more multi-core processors, one or more RISC processors, or one or more CISC processors.

In one aspect, each of processor 312 and processor 322 may be implemented in the form of one or more single-core processors, one or more multi-core processors, one or more RISC processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including disabling and enabling HARQ feedback for multi-TB in an IoT NTN in accordance with various implementations of the present disclosure.

In some implementations, apparatus 310 may also include a transceiver 316, as a communication device, coupled to processor 312 and capable of wirelessly transmitting and receiving data. In some implementations, apparatus 310 may further include a memory 314 coupled to processor 312 and capable of being accessed by processor 312 and storing data therein. In some implementations, apparatus 320 may also include a transceiver 326, as a communication device, coupled to processor 322 and capable of wirelessly transmitting and receiving data. In some implementations, apparatus 320 may further include a memory 324 coupled to processor 322 and capable of being accessed by processor 322 and storing data therein. Accordingly, apparatus 310 and apparatus 320 may wirelessly communicate with each other via transceiver 316 and transceiver 326, respectively.

To aid better understanding, the following description of the operations, functionalities and capabilities of each of apparatus 310 and apparatus 320 is provided in the context of an NTN communication environment in which apparatus 310 is implemented in or as a wireless communication device, a communication apparatus or a UE (e.g., UE 110 or an IoT device in communication environment 100) and apparatus 320 implemented in or as a network node (e.g., terrestrial network node 125 or non-terrestrial network node 128 in communication environment 100).

Under various proposed schemes pertaining to disabling and enabling HARQ feedback for multi-TB in an IoT NTN in accordance with the present disclosure, processor 312 of apparatus 310, as a UE, may receive, via transceiver 316, a configuration (e.g., from network 120 via apparatus 320 as terrestrial network node 125 or non-terrestrial network node 128). Moreover, processor 312 may apply, via transceiver 316, the configuration to disable or enable a HARQ feedback regarding multiple TBs.

In some implementations, in receiving the configuration, processor 312 may receive an RRC signaling. In some implementations, in receiving the RRC signaling, processor 312 may receive a respective UE-specific RRC signaling per HARQ process. In some implementations, the configuration may include an RRC bitmap. In such cases, each bit of the RRC bitmap may indicate enabling or disabling of the HARQ feedback regarding a respective TB of the multiple TBs.

In some implementations, in response to any one bit of the RRC bitmap indicating enabling of the HARQ feedback regarding a respective TB of the multiple TBs, the HARQ feedback regarding the multiple TBs may be enabled. Alternatively, in response to any one bit of the RRC bitmap indicating disabling of the HARQ feedback regarding a respective TB of the multiple TBs, the HARQ feedback regarding the multiple TBs may be disabled.

In some implementations, the configuration may include a one-bit field. For instance, the configuration may include a single enabling or disabling of the HARQ feedback indication that is applied to all scheduled multiple TBs.

In some implementations, the configuration may include an RRC bitmap, such that each bit of the RRC bitmap may indicate enabling or disabling of the HARQ feedback regarding a respective HARQ process. In such cases, an enabling or disabling of the HARQ feedback indication that is applied to all scheduled multiple TBs may be based on a HARQ process ID of 0 or a leftmost indication of the RRC bitmap.

In some implementations, in receiving the configuration, processor 312 may further receive a DCI signaling with an enabling or disabling of the HARQ feedback indication that overrides the configuration in the RRC signaling. In some implementations, the indication in the DCI signaling may be applied to all scheduled TBs of the multiple TBs. In some implementations, the enabling or disabling of the HARQ feedback may be indicated in either a new DCI field in the DCI signaling or in an existing DCI field that is re-interpreted. For instance, the enabling or disabling of the HARQ feedback may be indicated in the existing DCI field that is re-interpreted in NB-IoT and eMTC applications and wherein the existing DCI field that is re-interpreted comprises a HARQ-ACK related field. In some implementations, the enabling or disabling of the HARQ feedback indication in the DCI signaling may be only present in an event that the UE is configured with a higher-layer parameter npdsch-MultiTB-Config enabled in NB-IoT or with another higher-layer parameter ce-PDSCH-MultiTB-Con fig enabled in eMTC. Alternatively, or additionally, the enabling or disabling of the HARQ feedback indication in the DCI signaling may include a single indication in the DCI signaling that is applied to all scheduled multiple TBs.

In some implementations, the enabling or disabling of the HARQ feedback indication in the DCI signaling may include a bitmap. For instance, each bit of the bitmap may indicate enabling or disabling of the HARQ feedback regarding a respective TB of the multiple TBs. In such cases, in response to the bitmap indicating enabling of the HARQ feedback regarding a respective TB of the multiple TBs, the HARQ feedback of the multiple TBs may be enabled. Alternatively, in response to the bitmap indicating disabling of the HARQ feedback regarding a respective TB of the multiple TB, the HARQ feedback of the multiple TBs may be disabled.

In some implementations, in receiving the configuration, processor 312 may receive a DCI signaling that explicitly indicates the configuration. In some implementations, the configuration may include a single enabling or disabling of the HARQ feedback indication in the DCI signaling that is applied to all scheduled TBs of the multiple TBs. Alternatively, the configuration may include separate enabling or disabling of the HARQ feedback indications in the DCI signaling each of which applied to a respective scheduled TB of the multiple TBs.

In some implementations, the HARQ feedback may be based on a dedicated RRC parameter that indicates enabling or disabling of the HARQ feedback. In some implementations, the dedicated RRC parameter may be updated by a MAC CE.

In some implementations, in applying the configuration to disable or enable the HARQ feedback, processor 312 may enable or disable the HARQ feedback for all scheduled TBs of the multiple TBs based on an indication in the configuration.

Under various proposed schemes pertaining to disabling and enabling HARQ feedback for multi-TB in an IoT NTN in accordance with the present disclosure, processor 322 of apparatus 320, as a network node (e.g., terrestrial network node 125 or non-terrestrial network node 128 of network 120), may generate a configuration. Moreover, processor 322 may transmit, via transceiver 326, the configuration to a UE (e.g., apparatus 310 as UE 110) to cause the UE the UE to apply the configuration to disable or enable a HARQ feedback regarding multiple TBs. In some implementations, in transmitting the configuration, processor 322 may transmit a RRC signaling.

### Illustrative Processes

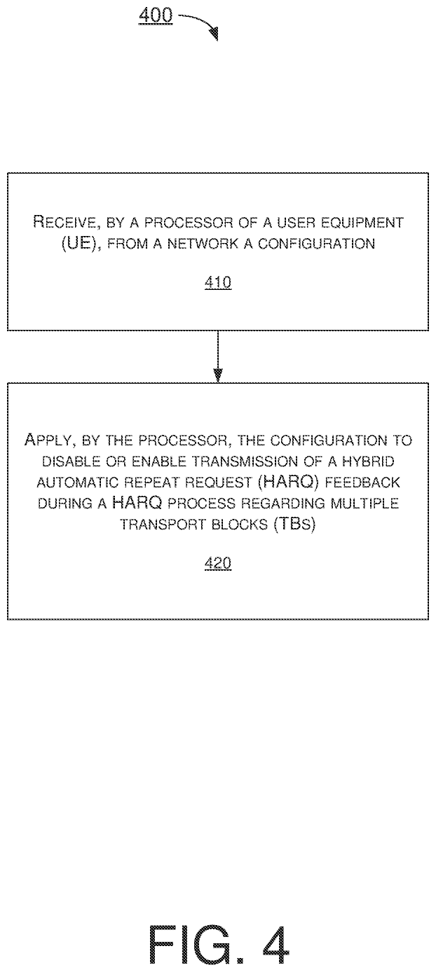

FIG. 4 illustrates an example process 400 in accordance with an implementation of the present disclosure. Process 400 may be an example implementation of the proposed schemes described above with respect to disabling and enabling HARQ feedback for multi-TB in an IoT NTN in accordance with the present disclosure. Process 400 may represent an aspect of implementation of features of apparatus 310 and apparatus 320. Process 400 may include one or more operations, actions, or functions as illustrated by one or more of blocks 410 and 420. Although illustrated as discrete blocks, various blocks of process 400 may be divided into additional blocks, combined into fewer blocks, or eliminated, depending on the desired implementation. Moreover, the blocks of process 400 may be executed in the order shown in FIG. 4 or, alternatively, in a different order. Process 400 may also be repeated partially or entirely. Process 400 may be implemented by apparatus 310, apparatus 320 and/or any suitable wireless communication device, UE, base station or machine type devices. Solely for illustrative purposes and without limitation, process 400 is described below in the context of apparatus 310 as a UE (e.g., UE 110 or an IoT device in communication environment 100) and apparatus 320 as a network node (e.g., terrestrial network node 125 or non-terrestrial network node 128 in communication environment 100). Process 400 may begin at block 410.

At block 410, process 400 may involve processor 312 of apparatus 310, as a UE (e.g., UE 110), receiving, via transceiver 316, a configuration (e.g., from network 120 via apparatus 320 as terrestrial network node 125 or non-terrestrial network node 128). Process 400 may proceed from block 410 to block 420.

At block 420, process 400 may involve processor 312 applying, via transceiver 316, the configuration to disable or enable a HARQ feedback regarding multiple TBs.

In some implementations, in receiving the configuration, process 400 may involve processor 312 receiving a RRC signaling. In some implementations, in receiving the RRC signaling, process 400 may involve processor 312 receiving a respective UE-specific RRC signaling per HARQ process. In some implementations, the configuration may include an RRC bitmap. In such cases, each bit of the RRC bitmap may indicate enabling or disabling of the HARQ feedback regarding a respective TB of the multiple TBs.

In some implementations, in response to any one bit of the RRC bitmap indicating enabling of the HARQ feedback regarding a respective TB of the multiple TBs, the HARQ feedback regarding the multiple TBs may be enabled. Alternatively, in response to any one bit of the RRC bitmap indicating disabling of the HARQ feedback regarding a respective TB of the multiple TBs, the HARQ feedback regarding the multiple TBs may be disabled.

In some implementations, the configuration may include a one-bit field. For instance, the configuration may include a single enabling or disabling of the HARQ feedback indication that is applied to all scheduled multiple TBs.

In some implementations, the configuration may include an RRC bitmap, such that each bit of the RRC bitmap may indicate enabling or disabling of the HARQ feedback regarding a respective HARQ process. In such cases, an enabling or disabling of the HARQ feedback indication that is applied to all scheduled multiple TBs may be based on a HARQ process ID of 0 or a leftmost indication of the RRC bitmap.

In some implementations, in receiving the configuration, process 400 may further involve processor 312 receiving a DCI signaling with an enabling or disabling of the HARQ feedback indication that overrides the configuration in the RRC signaling. In some implementations, the indication in the DCI signaling may be applied to all scheduled TBs of the multiple TBs. In some implementations, the enabling or disabling of the HARQ feedback may be indicated in either a new DCI field in the DCI signaling or in an existing DCI field that is re-interpreted. For instance, the enabling or disabling of the HARQ feedback may be indicated in the existing DCI field that is re-interpreted in NB-IoT and eMTC applications. In some implementations, the enabling or disabling of the HARQ feedback indication in the DCI signaling may be only present in an event that the UE is configured with a higher-layer parameter npdsch-MultiTB-Config enabled in NB-IoT or with another higher-layer parameter ce-PDSCH-MultiTB-Con fig enabled in eMTC. Alternatively, or additionally, the enabling or disabling of the HARQ feedback indication in the DCI signaling may include a single indication in the DCI signaling that is applied to all scheduled multiple TBs.

In some implementations, the enabling or disabling of the HARQ feedback indication in the DCI signaling may include a bitmap. For instance, each bit of the bitmap may indicate enabling or disabling of the HARQ feedback regarding a respective TB of the multiple TBs. In such cases, in response to the bitmap indicating enabling of the HARQ feedback regarding a respective TB of the multiple TBs, the HARQ feedback of the multiple TBs may be enabled. Alternatively, in response to the bitmap indicating disabling of the HARQ feedback regarding a respective TB of the multiple TB, the HARQ feedback of the multiple TBs may be disabled.

In some implementations, in receiving the configuration, process 400 may involve processor 312 receiving a DCI signaling that explicitly indicates the configuration. In some implementations, the configuration may include a single enabling or disabling of the HARQ feedback indication in the DCI signaling that is applied to all scheduled TBs of the multiple TBs. Alternatively, the configuration may include separate enabling or disabling of the HARQ feedback indications in the DCI signaling each of which applied to a respective scheduled TB of the multiple TBs.

In some implementations, the HARQ feedback may be based on a dedicated RRC parameter that indicates enabling or disabling of the HARQ feedback. In some implementations, the dedicated RRC parameter may be updated by a MAC CE.

In some implementations, in applying the configuration to disable or enable the HARQ feedback, process 400 may involve processor 312 disabling or enabling the HARQ feedback for all scheduled TBs of the multiple TBs based on an indication in the configuration.

FIG. 5 illustrates an example process 500 in accordance with an implementation of the present disclosure. Process 500 may be an example implementation of the proposed schemes described above with respect to disabling and enabling HARQ feedback for multi-TB in an IoT NTN in accordance with the present disclosure. Process 500 may represent an aspect of implementation of features of apparatus 310 and apparatus 320. Process 500 may include one or more operations, actions, or functions as illustrated by one or more of blocks 510 and 520. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may also be repeated partially or entirely. Process 500 may be implemented by apparatus 310, apparatus 320 and/or any suitable wireless communication device, UE, base station or machine type devices. Solely for illustrative purposes and without limitation, process 500 is described below in the context of apparatus 310 as a UE (e.g., UE 110 or an IoT device in communication environment 100) and apparatus 320 as a network node (e.g., terrestrial network node 125 or non-terrestrial network node 128 in communication environment 100). Process 500 may begin at block 510.

At block 510, process 500 may involve processor 322 of apparatus 320, as a network node (e.g., terrestrial network node 125 or non-terrestrial network node 128 of network 120), generating a configuration. Process 500 may proceed from block 510 to block 520.

At block 520, process 500 may involve processor 322 transmitting, via transceiver 326, the configuration to a UE (e.g., apparatus 310 as UE 110) to cause the UE the UE to apply the configuration to disable or enable a HARQ feedback regarding multiple TBs.

In some implementations, in transmitting the configuration, process 500 may involve processor 322 transmitting a RRC signaling.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of a user equipment (UE), a configuration; and
applying, by the processor, the configuration to disable or enable a hybrid automatic repeat request (HARQ) feedback regarding multiple transport blocks (TBs).

2. The method of claim 1, wherein the receiving of the configuration comprises receiving a radio resource control (RRC) signaling.

3. The method of claim 2, wherein the receiving of the RRC signaling comprises receiving a respective UE-specific RRC signaling.

4. The method of claim 2, wherein the configuration comprises a RRC bitmap, and wherein each bit of the RRC bitmap indicates enabling or disabling of the HARQ feedback regarding a respective TB of the multiple TBs.

5. The method of claim 4, wherein:
responsive to any one bit of the RRC bitmap indicating enabling of the HARQ feedback regarding a respective TB of the multiple TBs, the HARQ feedback regarding the multiple TBs is enabled, alternatively,
responsive to any one bit of the RRC bitmap indicating disabling of the HARQ feedback regarding a respective TB of the multiple TBs, the HARQ feedback regarding the multiple TBs is disabled.

6. The method of claim 2, wherein the configuration comprises a one-bit field, and wherein the configuration comprises a single enabling or disabling of the HARQ feedback indication that is applied to all scheduled multiple TBs.

7. The method of claim 2, wherein the configuration comprises a RRC bitmap, wherein each bit of the RRC bitmap indicates enabling or disabling of the HARQ feedback regarding a respective HARQ process, and wherein an enabling or disabling of the HARQ feedback indication that is applied to all scheduled multiple TBs is based on an indication for HARQ process identification (ID) of 0 of the RRC bitmap or a leftmost indication of the RRC bitmap.

8. The method of claim 2, wherein the receiving of the configuration further comprises receiving a downlink control information (DCI) signaling with an enabling or disabling of the HARQ feedback indication that overrides the configuration in the RRC signaling.

9. The method of claim 8, wherein the enabling or disabling of the HARQ feedback is indicated in either a new DCI field in the DCI signaling or in an existing DCI field that is re-interpreted, and wherein the existing DCI field that is re-interpreted comprises a HARQ-ACK related field.

10. The method of claim 8, wherein the enabling or disabling of the HARQ feedback indication in the DCI signaling is only present in an event that the UE is configured with a higher-layer parameter npdsch-MultiTB-Config enabled in narrowband Internet-of-Things (NB-IoT) or with another higher-layer parameter ce-PDSCH-MultiTB-Config enabled in enhanced machine-type communication (eMTC).

11. The method of claim 8, wherein the enabling or disabling of the HARQ feedback indication in the DCI signaling comprises a single indication in the DCI signaling that is applied to all scheduled multiple TBs.

12. The method of claim 8, wherein the enabling or disabling of the HARQ feedback indication in the DCI signaling comprises a bitmap, and wherein each bit of the bitmap indicates enabling or disabling of the HARQ feedback regarding a respective TB of the multiple TBs.

13. The method of claim 12, wherein:
responsive to one bit of the bitmap indicating enabling of the HARQ feedback regarding a respective TB of the multiple TBs, the HARQ feedback of the multiple TBs is enabled, alternatively,
responsive to one bit of the bitmap indicating disabling of the HARQ feedback regarding a respective TB of the multiple TB, the HARQ feedback of the multiple TBs is disabled.

14. The method of claim 1, wherein the receiving of the configuration comprises receiving a downlink control information (DCI) signaling that explicitly indicates the configuration.

15. The method of claim 14, wherein the enabling or disabling of the HARQ feedback is indicated in either a new DCI field in the DCI signaling or in an existing DCI field that is re-interpreted, and wherein the existing DCI field that is re-interpreted comprises a HARQ-ACK related field.

16. The method of claim 14, wherein the configuration comprises a single enabling or disabling of the HARQ feedback indication in the DCI signaling that is applied to all scheduled TBs of the multiple TBs.

17. The method of claim 14, wherein the configuration comprises separate enabling or disabling of the HARQ feedback indications in the DCI signaling each of which applied to a respective scheduled TB of the multiple TBs, wherein
responsive to one of the enabling or disabling of the HARQ feedback indications indicating enabling, the HARQ feedback regarding the multiple TBs is enabled, alternatively,
responsive to one of the enabling or disabling of the HARQ feedback indications indicating disabling, the HARQ feedback regarding the multiple TBs is disabled.

18. The method of claim 1, wherein the HARQ feedback is based on a dedicated radio resource control (RRC) parameter that indicates enabling or disabling of the HARQ feedback, and wherein the dedicated RRC parameter is updated by a medium access control (MAC) control element (CE).

19. A method, comprising:
generating, by a network node in a network, a configuration; and
transmitting, by the network node, the configuration to a user equipment (UE), thereby causing the UE to apply the configuration to disable or enable a hybrid automatic repeat request (HARQ) feedback regarding multiple transport blocks (TBs).

20. The method of claim 19, wherein the transmitting of the configuration comprises transmitting at least one of a radio resource control (RRC) signaling and a downlink control information (DCI) signaling.
